(19) United States
(12) Patent Application Publication
(10) Pub. No.: US 2018/0137954 A1
(43) Pub. Date: May 17, 2018

(54) Manufacture Support Method and Non-Transitory Computer-Readable Storage Medium

(71) Applicant: Yazaki Corporation, Tokyo (JO)

(72) Inventors: Shingo Hasegawa, Toyota-shi (JP); Kota Oishi, Toyota-shi (JP); Yu Ichikawa, Makinohara-shi (JP)

(73) Assignee: Yazaki Corporation, Tokyo (JP)

(21) Appl. No.: 15/787,099

(22) Filed: Oct. 18, 2017

(30) Foreign Application Priority Data
Oct. 18, 2016 (JP) 2016-204694

(51) Int. Cl. H01B 13/012; G06F 17/50; H01B 7/36; B60R 16/02

(52) U.S. Cl. CPC H01B 13/01209; G06F 17/509; G06F 2217/36; B60R 16/0207; G06F 17/5095; H01B 7/36

(57) ABSTRACT

A manufacture support method for generating second design drawing data based on first design drawing data representing a configuration of a wire harness, includes the steps of: generating pieces of unique address information for nodes indicating dimension measuring points in the wire harness, respectively, and assigning the pieces of address information to respective nodes of a wire harness on the second design drawing data; and in determining numbers of the pieces of unique address information, assigning numbers to the respective nodes along a routing path of the wire harness.

### CROSS REFERENCE TO RELATED APPLICATIONS

This application is based on Japanese Patent Application (No. 2016-204694) filed on Oct. 18, 2016, the contents of which are incorporated herein by reference.

### BACKGROUND OF THE INVENTION

### 1. Field of the Invention

The present invention relates to a manufacture support method and a non-transitory computer-readable storage medium that can be used for manufacture of a wire harness that is used in a vehicle etc.

### 2. Description of the Related Art

In vehicles, it is necessary to supply electric power properly to a very large number of and various kinds of electric devices from an alternator (generator) and a battery which are main power sources. It is also necessary to connect those various kinds of electric devices to various electronic control units (ECUs) for controlling them and to connect plural ECUs to each other to enable communication between them.

Thus, in ordinary vehicles, individual portions of a wire harness that is a collection of a large number of wires are routed along prescribed routing paths in the vehicle, whereby individual devices of the vehicle are connected to each other by the wire harness.

In actuality, a component manufacturer manufactures a wire harness product by assembling constituent elements such as about several hundreds of wires, terminals, connectors, and clamps according to a design drawing into such a shape that it can be routed along routing paths determined in the design drawing. A vehicle manufacturer manufactures a vehicle by mounting the wire harness purchased from the component manufacturer on a vehicle body.

In manufacturing such a wire harness, it is necessary to consider various factors such as reduction of the overall weight, the manufacturing work efficiency, reduction of the manufacturing cost, and the quality of manufactured products. Various techniques relating to these factors have been proposed in the art.

JP-A-2006-114328 discloses a technique for making improvements on what are inefficient in designing and manufacture of a wire harness. More specifically, a device layout drawing and an electronic wire list are read by a design data reading unit 3 of an apparatus for generating a harness routing model and routing instructions, a harness routing model is generated by a harness routing model generation unit 4, a routing work commanding apparatus capable of generating a work procedure is implemented by a work procedure generation unit 6, and routing work is carried out using the routing work commanding apparatus.

JP-A-2007-304813 discloses a CAD data management system that has a simple configuration and can perform component list management etc. easily. More specifically, the CAD data management system is equipped with a component identification number assigning means 1 for assigning component identification numbers to component management data for management of a vehicle component list, a drawing identification number assigning means 2 for assigning drawing identification numbers to CAD data that correspond to the component-identification-number-assigned component list, a storage means 3 for storing the CAD data that are assigned the drawing identification numbers, and a control means 5 for reading the CAD data that are assigned the drawing identification numbers from the storage means 3 in response to a CAD data reading manipulation and displaying the read-out CAD data on a display means 4.

JP-A-2010-287407 discloses a technique for reducing the number of wire colors of wires to be routed in a vehicle. More specifically, among wires constituting one wire harness, wires having the same color are provided with, on a ground color surface, a print portion where at least a circuit number is printed.

For example, it is necessary for a component manufacturer to check, through an inspection, before delivery, whether manufactured wire harnesses satisfy quality that is required by a vehicle manufacturer. More specifically, actual dimensions between plural dimension measuring points in each wire harness are measured and compared with their design values and allowances. For example, branching points in the wire harness, positions where such components as protectors are mounted, and other points are employed as the dimension measuring points.

In a component manufacturer, there arises an occasion for studying a partial change of the configuration of a wire harness or a change of components of a wire harness to reduce its manufacturing cost. For example, it may become necessary to change the position of a joint that connects plural wires or the structures of plural subharnesses that constitute a wire harness. By changing the structures of subharnesses, it becomes possible to increase the automation ratio of pieces of work of fitting the terminals of individual wires to the cavities of connectors, leading to reduction of the manufacturing cost.

When a designer studies a partial change of the configuration of a wire harness or a change of components of a wire harness, usually, design drawing data are read into a computer and constituent elements of the wire harness, connection relationships between plural constituent elements, routing paths, etc. are displayed on a screen. The designer checks the appropriateness of a change repeatedly on a trial-and-error basis while looking at displays on the screen.

Incidentally, individual elements such as components and dimension measuring points are assigned respective numbers on a design drawing. These numbers may also be called addresses. Thus, each component or dimension measuring point can be identified by designating its number. These numbers can be used in, as mentioned above, performing a dimension inspection on a wire harness before its delivery or studying a partial change of the configuration of a wire harness or a change of components of a wire harness.

However, numbers are assigned to respective elements such as components and dimension measuring points on a design drawing with no consideration given to convenience of manufacture of the wire harness, convenience of an inspection, convenience of studying of the configuration, and like factors. That is, since a wire harness constitutes merely a small part of a vehicle, in many cases large numbers of about five digits are assigned to respective elements of the wire harness in a design drawing that is presented to a component manufacturer by a vehicle manufacturer.

As a result, for example, in inspecting dimensions of a wire harness on the basis of such a design drawing, a component manufacturer follows, for example, a procedure of finding a dimension measuring point having a number “12345” and a dimension measuring point having a number “12567,” actually measuring a dimension of the interval between these points, and comparing the measured dimension with a specified dimension and an allowance of this interval. Work of identifying the dimension measuring points and finding the specified dimension takes time and labor.

Furthermore, in studying a partial change of the configuration of a wire harness or a change of components of a wire harness, a designer refers to numbers that are assigned to nodes such as dimension measuring points to identify components and find their positions. However, since the numbers assigned to the respective nodes are determined irrespective of the configuration of the wire harness and routing paths, it is difficult to understand routing details from the numbers. For example, it is very difficult to recognize, by tracing numbers, what locations are connected by a certain wire. Thus, it is very difficult for a designer to study a partial change of the configuration or a change of components of a wire harness having a complex configuration.

### SUMMARY OF THE INVENTION

The present invention has been made in view of the above circumstances, and an object of the invention is therefore to provide a manufacture support method and a non-transitory computer-readable storage medium that make it possible to output numbers that help to increase the efficiency of kinds of work of, for example, manufacturing, inspecting, and studying a design change of a wire harness.

To attain the above object, the invention provides manufacture support methods of the following items (1) to (8):

(1) A manufacture support method for generating second design drawing data based on first design drawing data representing a configuration of a wire harness, the manufacture support method comprising:

generating pieces of unique address information for nodes indicating dimension measuring points in the wire harness, respectively, and assigning the pieces of address information to respective nodes of a wire harness on the second design drawing data; and

in determining numbers of the pieces of unique address information, assigning numbers to the respective nodes along a routing path of the wire harness.

(2) The manufacture support method according to item (1), further comprising:

receiving a user input for selecting a particular constituent element to be made a base point among constituent elements of the wire harness; and

in determining numbers of the pieces of unique address information, assigning numbers to the respective nodes starting from a node that is closest to the base point which is a position of the selected constituent element.

(3) The manufacture support method according to item (1) or (2), wherein in determining numbers of the pieces of unique address information, a smaller number is assigned preferentially to a node that is closer to a terminal in a routing path of the wire harness.

(4) The manufacture support method according to any one of items (1) to (3), wherein in determining numbers of the pieces of unique address information, in processing a branching node indicating a branching point of the routing path, a smaller number is assigned preferentially to a branch a numerical value of whose attribute representing its characteristic is smaller among branches branched at the branching point.

(5) The manufacture support method according to any one of items (1) to (4), wherein in determining numbers of the pieces of unique address information, consecutive numbers are assigned, in order, to nodes that are located between a terminal node indicating one terminal in the routing path and a branching node indicating one branching point in the routing path.

(6) The manufacture support method according to item (1), wherein in determining numbers of the pieces of unique address information, consecutive numbers or numbers having a specified increment are assigned to the nodes in order.

(7) The manufacture support method according to any one of items (1) to (6), further comprising: displaying the routing path and the nodes of the wire harness based on the first design drawing data or the second design drawing data, and displaying the pieces of unique address information assigned to the respective nodes in the vicinities of the respective nodes.

(8) The manufacture support method according to item (7), further comprising: displaying dimension values assigned as distances between respective pairs of nodes at positions adjacent to the routing path.

In the manufacture support method of item (1), since numbers determined in order along the routing path of the wire harness are made pieces of address information of the nodes, respectively, the magnitudes of the numbers of the pieces of address information closely relate to structures of and connection relationships between individual portions such as trunks, branching points, and branches of the routing path. This makes it possible to assign small-digit numbers to the respective nodes. For example, in measuring a dimension between two dimension measuring points in the wire harness, pieces of address information that are assigned to the nodes of the two dimension measuring points are numbers close to each other. That is, the two dimension measuring points can be found from the pieces of address information concerned.

According to the manufacture support method of item (2), a user such as a designer can select a constituent element to be made a base point and hence the relationship between the order of numbers of respective pieces of address information and the flows of the routing path can be changed in a manner the user desires. This makes it possible to assign easier-to-use numbers to the respective nodes. For example, an inspection process can be executed efficiently by measuring, together, dimensions of locations that are connected to the same branching point. As such, assigning numbers from the base point specified by the user leads to increase of the efficiency.

According to the manufacture support method of item (3), pieces of address information can be determined so that their numbers increase in order from a terminal of the wire harness to a trunk. Thus, a designer or the like who refers to pieces of address information looking at a design drawing can easily recognize flows of paths and their connection relationships on the basis of differences between the magnitudes of assigned numbers.

According to the manufacture support method of item (4), smaller numbers can be assigned to nodes having a simpler structure in the routing path. For example, it is highly probable that, of two branches that branch off a trunk at a branching node, a branch whose attribute such as the number of dimension measuring points is smaller is simpler in structure. Smaller numbers can be assigned to that branch preferentially.

According to the manufacture support method of item (5), numbers closer to each other can be assigned to nodes located between a terminal node and a branching node. This allows a designer or the like who refers to pieces of address information to easily recognize the structure of the path on the basis of the magnitudes of the numbers.

The manufacture support method of item (6) makes it possible to assign numbers that vary regularly because consecutive numbers or numbers having a specified increment are assigned in order. This allows a designer or the like who refers to pieces of address information to easily recognize the structures of the path on the basis of differences between the magnitudes of the numbers and their regularity.

According to the manufacture support method of item (7), a user such as a designer can easily recognize, visually, the routing path and the nodes of the wire harness and the pieces of address information assigned to the respective nodes by looking at a display on the screen.

According to the manufacture support method of item (8), a user such as a designer can easily recognize, visually, the routing path and the nodes of the wire harness, the pieces of address information assigned to the respective nodes, and the values of dimensions between the nodes by looking at a display on the screen.

To attain the above object, the invention provides a non-transitory computer-readable storage medium which includes a manufacture support program of the following item (9):

(9) A non-transitory computer-readable storage medium, which includes a manufacture support program that causes a computer to execute the manufacture support method, according to any one of items (1) to (8).

In the non-transitory computer-readable storage medium including the manufacture support program of item (9), by running this program on a prescribed computer, numbers determined in order along the routing path of the wire harness are made pieces of address information of the nodes, respectively. The magnitudes of the numbers of the pieces of address information closely relate to structures of and connection relationships between individual portions such as trunks, branching points, and branches of the routing path. This makes it possible to assign small-digit numbers to the respective nodes. For example, in measuring a dimension between two dimension measuring points in the wire harness, pieces of address information that are assigned to the nodes of the two dimension measuring points are numbers close to each other. That is, the two dimension measuring points can be found from the pieces of address information concerned.

The manufacture support method and the non-transitory computer-readable storage medium including the manufacture support program make it possible to output numbers that help to increase the efficiency of kinds of work of, for example, manufacturing, inspecting, and studying a design change of a wire harness, for respective nodes in the form of pieces address information. That is, since the magnitudes of numbers to be assigned to the respective nodes are determined in order along wiring path, it becomes easier to recognize, among other things, connection relationships between the nodes in the routing path on the basis of the magnitudes of the numbers and differences between them.

The invention has been described above concisely. The details of the invention will become more apparent when the modes for carrying out the invention (hereinafter referred to as an embodiment) described below are read through with reference to the accompanying drawings.

### BRIEF DESCRIPTION OF THE DRAWINGS

FIG. 1 is a flowchart showing a typical processing procedure of an address drawing generation function.

FIG. 2 shows the configuration of an example system for performing a manufacture support method according to an embodiment of the present invention.

FIG. 3 is a plan view showing an example configuration of a main part of a wire harness that is displayed on, for example, the screen as a figure α.

FIG. 4 is a plan view showing the figure α of FIG. 3 added with generated pieces of address information.

FIG. 5 is a plan view of a region A1 that is part of FIG. 3 and shows a location where a clamp dimension should be measured.

FIG. 6 is a plan view of the region A1 that is part of FIG. 3 and shows locations where a terminal dimension should be measured.

FIG. 7 is a plan view of the region A1 that is part of FIG. 3 and shows locations where a trunk dimension should be measured.

FIG. 8 outlines order and directions of assigning of pieces of address information on the routing paths of the wire harness.

FIG. 9 is a table showing a list of attributes included in an MT data

FIG. 10 is a table showing an example set of pieces of information belonging to a “node” attribute that is included in the MT data.

FIG. 11 is a table showing an example set of pieces of information belonging to a “segment” attribute that is included in the MT data.

FIG. 12 is a table showing an example set of pieces of information belonging to a “dimension” attribute that is included in the MT data.

FIG. 13 is a flowchart of a modification of the processing procedure shown in FIG. 1.

### DETAILED DESCRIPTION OF THE EXEMPLARY EMBODIMENTS

A manufacture support method and a non-transitory computer-readable storage medium including a manufacture support program according to a specific embodiment of the present invention will be hereinafter described with reference to the drawings.

<Specific Example Environment in which Manufacture Support Method is Employed>

For example, when a vehicle manufacturer (company A) has a component manufacturer (company B) manufacture a wire harness to be mounted on a vehicle manufactured by company A, usually, company A supplies company B with design drawing data (first design drawing data) that represent the wire harness. The design drawing data are data that can be used on a particular CAD (computer-aided design) system introduced in company A and are in such a form as to be easy to use in company A.

Company B manufactures wire harness products on the basis of the design drawing data received from company A. Company B checks, by an inspection including actual measurements of dimensions, whether each wire harness product satisfies a specification required by company A and delivers wire harness products that have passed the inspection to company A. Company A manufacture vehicles by mounting the wire harness products delivered from company B on vehicle bodies of a particular kind.

In the above environment, company B manufacture wire harness products that satisfy the design drawing data received from company A. In doing so, company B makes various kinds of studies on the wire harness to be manufactured mainly for the purpose of reducing its cost. Company B studies the probability of cost reduction not only in a manufacturing process but also in an inspection process. For cost reduction or some other purpose, company B sometimes proposes, to company A, a design change in the design drawing data received from company A.

Convenience of manufacture and an inspection in company B and like factors are not taken into consideration in the design drawing data that company B receives from company A. Thus, company B generates easy-to-use design drawing data (second design drawing data) on the basis of the received design drawing data (first design drawing data) by taking convenience in company B into consideration. More specifically, if company B does not employ the same CAD system as employed in company A, company B generates design drawing data of a highly versatile form such as a text form from the design drawing data of a data form that is dedicated to the CAD system of company A, and manufacture and inspect wire harness products using the generated second design drawing data.

Instead of merely changing the data form of the design drawing data, company B sometimes add data that are useful for cost reduction or data that are useful for a configuration study. In practicing the manufacture support system according to the invention, pieces of address information of easy-to-use numbers can be assigned to nodes that correspond to respective dimension measuring points in a wire harness. The dimension measuring points are reference points of measurement of dimensions in an actual wire harness.

For example, it is necessary to manufacture a wire harness so that actual dimensions between each dimension measuring point and other dimension measuring points satisfy corresponding sets of conditions, that is, sets of a reference dimension and an allowance, prescribed in the design drawing data, measure actual dimensions of the manufactured wire harness, and check whether the actual dimensions satisfy the sets of conditions.

### <Example System Configuration>

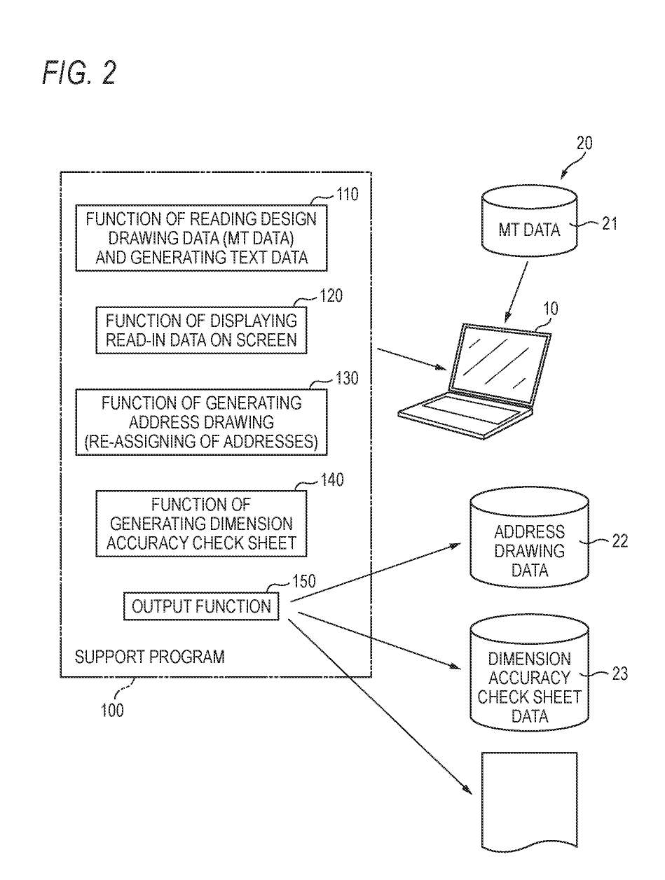

FIG. 2 shows the configuration of an example system for performing the manufacture support method according to the embodiment of the invention. The system shown in FIG. 2 is equipped with a computer 10, a memory, and a support program 100 which can run on the computer 10. The support program 100 is stored in the memory.

The computer 10 may be a general computer such as a notebook PC in which basic software (operating system) such as Windows of Microsoft Corp. is installed.

Design drawing data that are necessary for manufacture of a target wire harness are supplied to company B from company A in the form of MT data 21 using a proper recording medium 20. In company B, the MT data 21 on the recording medium 20 are read into the computer 10 and used.

By running the support program 100 on the computer 10 with the memory, it is possible to generate design drawing data that are easy to use to company B, on the basis of the MT data 21. The support program 100 stored in the memory shown in FIG. 2 includes a function 110 of generating text data, a function 120 of displaying read-in data on the screen, a function 130 of generating an address drawing, a function 140 of generating a dimension accuracy check sheet, and an output function 150.

The text data generation function 110 is implemented as a program for reading, on the computer 10, the MT data 21 which can be used on a particular CAD system, and generating data in a text form that is highly versatile.

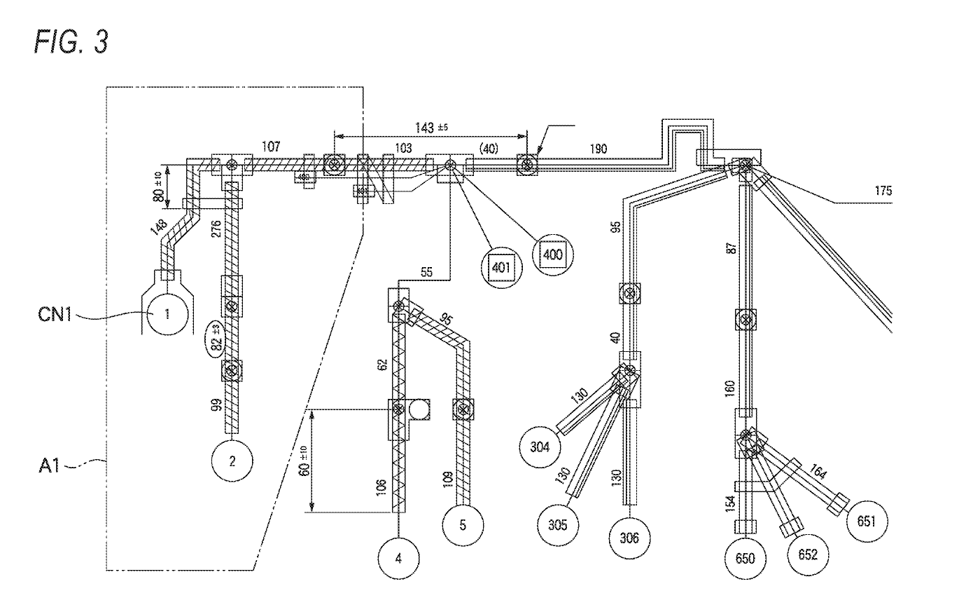

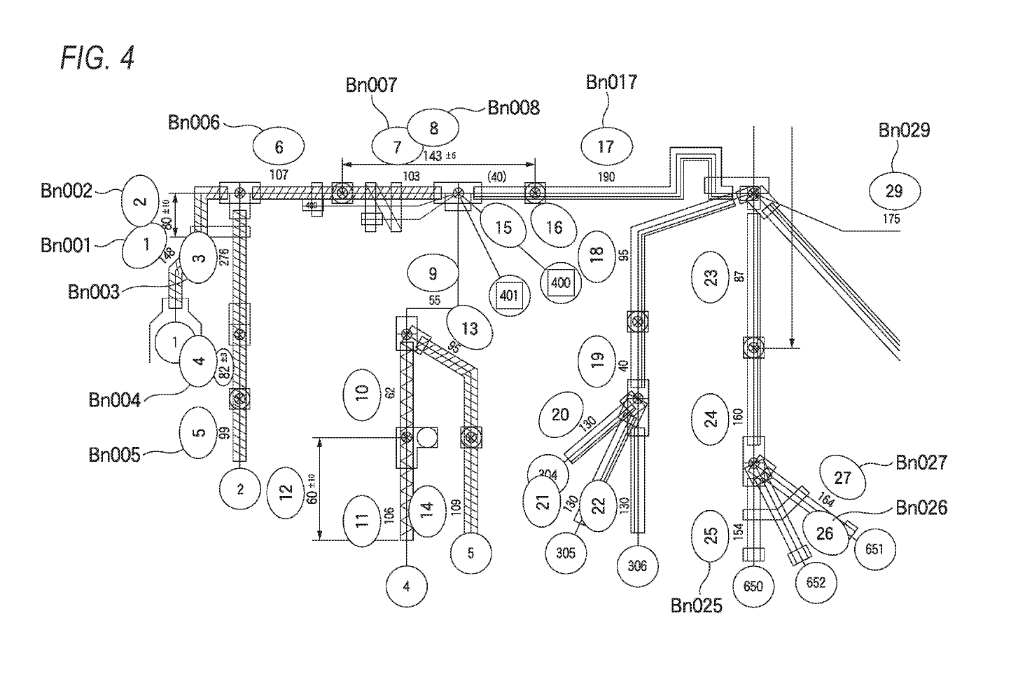

The function 120 of displaying read-in data on the screen is implemented as a program for displaying, on the screen of the computer 10, various kinds of information representing the manufacture target wire harness on the basis of the text-form data generated by the function 110. For example, the function 120 can display information shown in FIG. 3 and information shown in FIG. 4 on the screen.

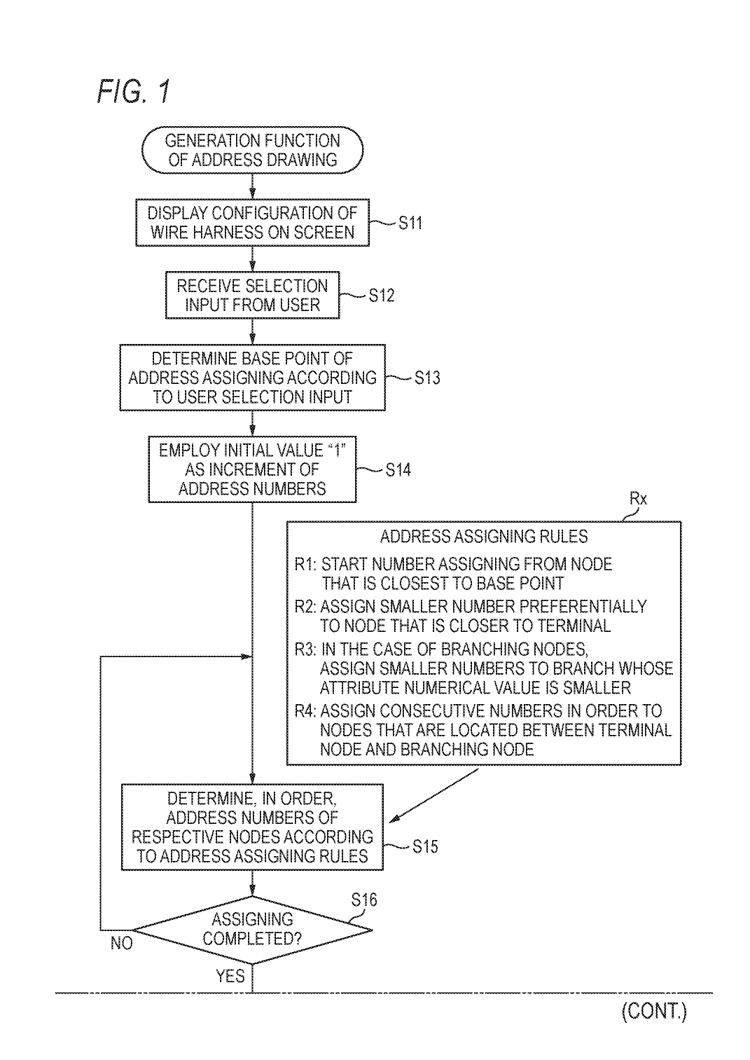

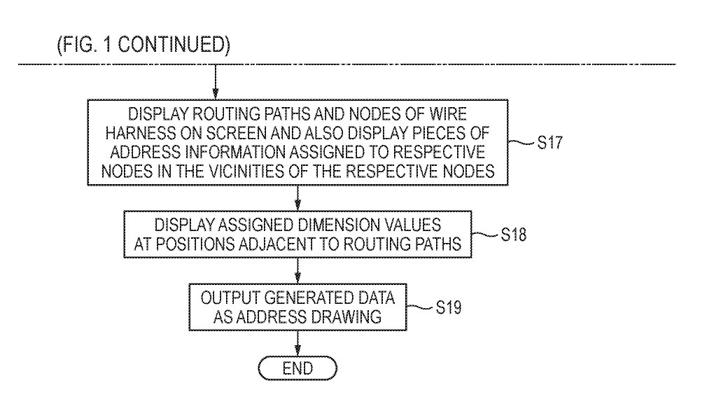

The address drawing generation function 130 is implemented as a program for assigning pieces of address information to respective nodes in the wire harness and re-assigning addresses. FIG. 1 shows a detailed procedure (described later) of this program.

The dimension accuracy check sheet generation function 140 is implemented as a program for automatically generating, on the basis of the text data, data to be used in an inspection process of measuring actual dimensions of a manufactured wire harness and checking whether the measured dimensions satisfy corresponding sets of specified conditions, that is, sets of a reference dimension and an allowance.

The output function 150 is implemented as a program for outputting address drawing data 22 and dimension accuracy check sheet data 23 on the screen or sheets or to a file or the like on the basis of an output of the address drawing generation function 130 of the dimension accuracy check sheet generation function 140. The address drawing data 22 are data in which pieces of address information are added to figure α data that are included in the MT data 21.

### <MT Data 21>

### <List of Attributes>

FIG. 9 shows a list of attributes included in the MT data 21. As shown in FIG. 9, the MT data 21 includes drawing data of three kinds of drawings, that is, figures α, β, and γ. The figure α drawing data include elements of respective attributes “node,” “segment,” “dimension,” “tape,” “tube,” “sheet,” and “parts.”

The figure β drawing data include elements of respective attributes “connector” and “cavity.” The figure γ drawing data include data of an element “WIRE.”

### <Example Pieces of Information Belonging to “Node” Attribute>

FIG. 10 shows an example set of pieces of information belonging to the “node” attribute that is included in the MT data 21. As shown in FIG. 10, the example set of pieces of information belonging to the “node” attribute includes address information “Rec.No.,” a node ID “RTN ID,” an X coordinate, a Y coordinate, and a connection component ID.

### <Example Pieces of Information Belonging to “Segment Attribute”>

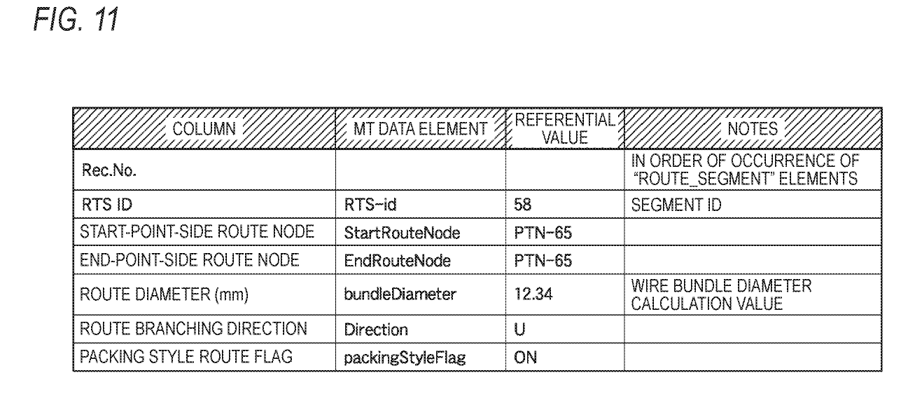

FIG. 11 shows example set of pieces of information belonging to the “segment” attribute that is included in the MT data 21. As shown in FIG. 11, the example set of pieces of information belonging to the “segment” attribute includes address information “Rec.No.,” a segment ID “RTS ID,” a start-point-side route node, an end-point-side route node, a route diameter, a route branching direction, and a packing style route flag.

### <Example Pieces of Information Belonging to “Dimension” Attribute>

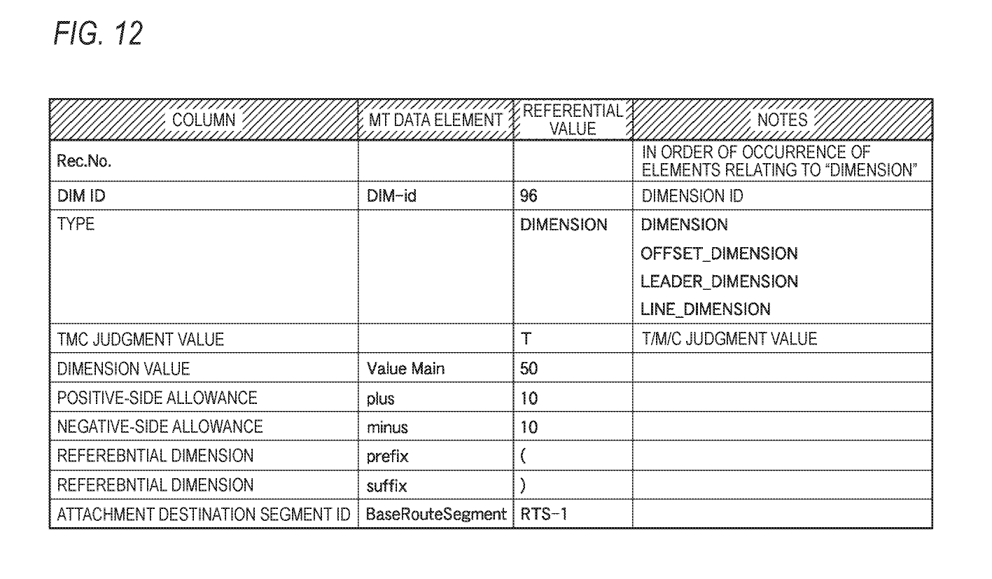

FIG. 12 shows example set of pieces of information belonging to the “dimension” attribute that is included in the MT data 21. As shown in FIG. 12, the example set of pieces of information belonging to the “dimension” attribute includes address information “Rec.No.,” a dimension ID “DIM-ID,” a type, a TMC judgment value, a dimension value, a positive-side allowance, a negative-side allowance, referential dimensions “prefix” and “suffix,” and an attachment destination segment ID. T, M, or C of the TMC judgment value indicates a terminal(T), trunk(M), and clamp(C) respectively.

### <Address Drawing Generation Function 130>

### <Processing Procedure>

FIG. 1 shows a typical processing procedure of the address drawing generation function 130 of the support program 100. This processing procedure includes the manufacture support method and the manufacture support program according to the embodiment of the invention. The processing procedure shown in FIG. 1 will be described below.

At step S11, various kinds of information indicating the configuration of a wire harness that is determined by a read-in MT data 21 are displayed on the screen of the computer 10 in, for example, a form shown in FIG. 3. That is, structures and manners of connection of individual portions of the wire harness to be routed along prescribed routing paths are displayed on the screen.

At step S12, the computer 10 receives a selection input from a user. A situation is assumed here that the user selects a base location where to start assigning of addresses. A specific example is that the user selects a connector CN1 as a desired component from the various constituent elements shown in FIG. 3 by moving a mouse cursor on the screen of the computer 10 according to a user input manipulation.

At step S13, the computer 10 determines a base point of address assigning according to the user selection input received at step S12. For example, if the user selects the connector CN1, the computer 10 sets the location of the connector N1 as a base point.

At step S14, the computer 10 employs an initial value “1” as an increment of numbers to be used in address assigning processing to follow.

At step S15, the computer 10 determines, in order, address numbers of respective nodes in the wire harness according to address assigning rules Rx determined in advance. Each node is a dimension measuring point that is a reference point of a dimension measurement.

As shown in FIG. 1, in the embodiment, the address assigning rules Rx are four rules R1, R2, R3, and R4. The rule R1 is “Start number assigning from a node that is closest to the base point.” The rule R2 is “Assign a smaller number preferentially to a node that is closer to a terminal.” The rule R3 is “In the case of branching nodes, assign smaller numbers to a branch whose attribute numerical value is smaller.” The rule R4 is “Assign consecutive numbers in order to nodes that are located between a terminal node and a branching node.” For example, the branching node is defined as a node having three or more elements “ROUTE SEGMENT” that are connected to element “ROUTE NODE.”

By executing step S15 repeatedly, the computer 10 assigns address numbers to all nodes in order. Upon completion of assigning of addresses to all the nodes, the process moves to step S17 via step S16.

At step S17, the computer 10 displays routing paths and the nodes of the wire harness on the screen and also displays pieces of address information assigned to the respective nodes in the vicinities of the respective nodes. That is, the computer 10 displays pieces of address information assigned to the respective nodes at step S15 in such a manner that they are added to picture displayed at step S11.

At step S18, the computer 10 displays dimension values (design reference values) that are assigned to respective segments each of which is determined by two nodes at positions adjacent to the routing paths of the wire harness.

At step S19, the computer 10 outputs, as an address drawing, the data that have been generated by steps S11-S18. The address drawing is the figure α of the MT data 21 plus the pieces of address information of the respective nodes.

The address drawing generation function 130 shown in FIG. 2 can be performed repeatedly. Thus, numbers can be assigned again if the user selects a new base point and causes the address drawing generation function 130 to be performed again after previous assigning of pieces of address information. In this manner, the order of address numbers assigned to the respective nodes can be changed to order as desired by the user.

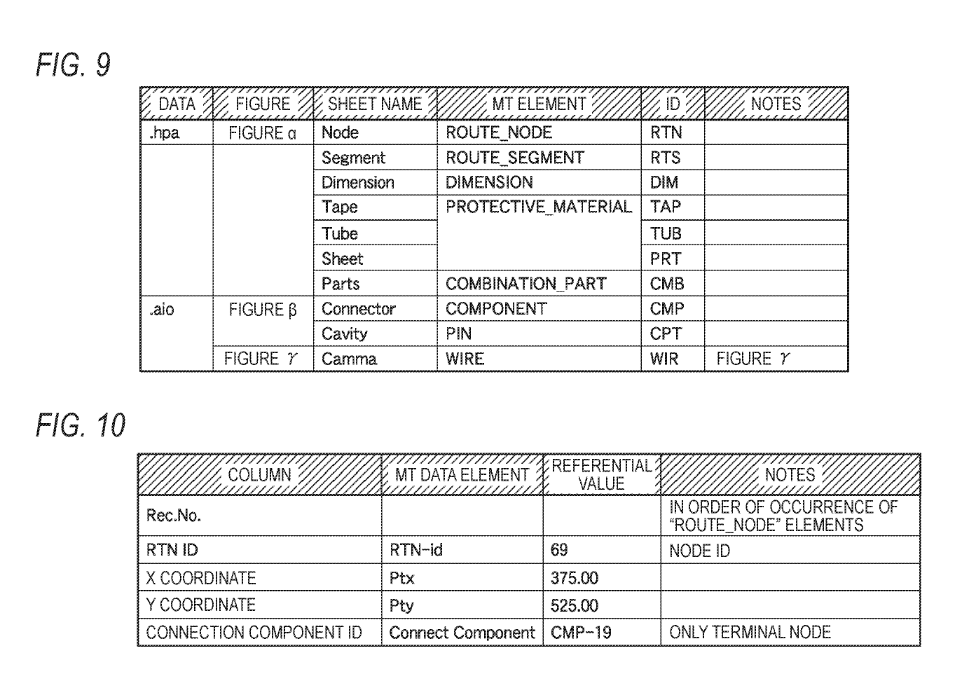

FIG. 8 outlines order and directions of assigning of pieces of address information on the routing paths of the wire harness. For example, if the user selects, as a base point, a location at the bottom-left end in FIG. 8, pieces of address information are assigned along the routing paths of the wire harness in such a manner that the address number increases in order indicated by arrows shown in FIG. 8, that is, upward from the bottom-left end, then rightward from the left end, and then upward and downward from the right-end center.

### <Specific Display Example>

For example, if the user selects a connector CN1 in a state that the figure α shown in FIG. 3 is displayed on the screen of the computer 10 and starts execution of the process shown in FIG. 1, the display on the screen is updated to the address drawing shown in FIG. 4. That is, the figure α plus the pieces of address information of the respective nodes are displayed.

In the picture shown in FIG. 4, various address indications Bn001, Bn002, Bn003, . . . , Bn029 are displayed in the vicinities of the respective nodes. Each of the address indications Bn001, Bn002, Bn003, . . . , Bn029 constitutes a number “1,” “2,” “3,” . . . , “29” and an elliptical pattern that surrounds the number and colored in a prescribed color.

In the address drawing shown in FIG. 4, the numbers “1” to “28” which are assigned to the respective address indications Bn001 to Bn029 are consecutive numbers having an increment “1” employed at step S14 and are assigned so as to increase in order along the routing paths of the wire harness.

### <Example Use>

For example, when the component manufacturer carries out an inspection before delivering manufactured wire harness products to the vehicle manufacturer, it is necessary to find individual dimension measuring points in the wire harness, measure actual dimensions between the nodes, and compare the measurement results with sets of a reference value and an allowance of corresponding dimensions specified in the design drawing (MT data 21).

Where the address drawing as shown in FIG. 4 is used, positions of respective dimension measuring points can be determined easily because the address indications Bn001-Bn029 which are small-digit numbers are assigned the respective nodes which are dimension measuring points. Furthermore, since these numbers are assigned so as to increase in order along the routing paths of the wire harness, in measurement work target locations can be determined easily by tracing the numbers along the routing paths.

For example, it can be said that measurement work can be done efficiently by measuring, together, dimensions of a particular group of locations downstream of a certain branching point on the routing paths of the wire harness. Assigning numbers close to each other to all nodes of such a group (same group) can increase the efficiency of the measurement work.

A designer frequently studies a change of a detailed structure of a wire harness to be manufactured actually for the purpose of, for example, reduction of the component cost or the manufacturing cost. In such a case, the designer can conduct such a study easily if he or she can utilize an address drawing as shown in FIG. 4. That is, since the magnitudes and the order of numbers of pieces of address information assigned to respective nodes reflect the details of the routing paths of the wire harness, the designer can easily find a target location through inference using numbers of pieces of address information. In particular, since small-digit numbers are assigned to respective pieces of address information, individual locations can be identified and collated easily and hence the work is facilitated even in a case of a wire harness to be manufactured is complex in configuration.

### <Specific Example of Dimension Measurement>

### <Clamp Dimension>

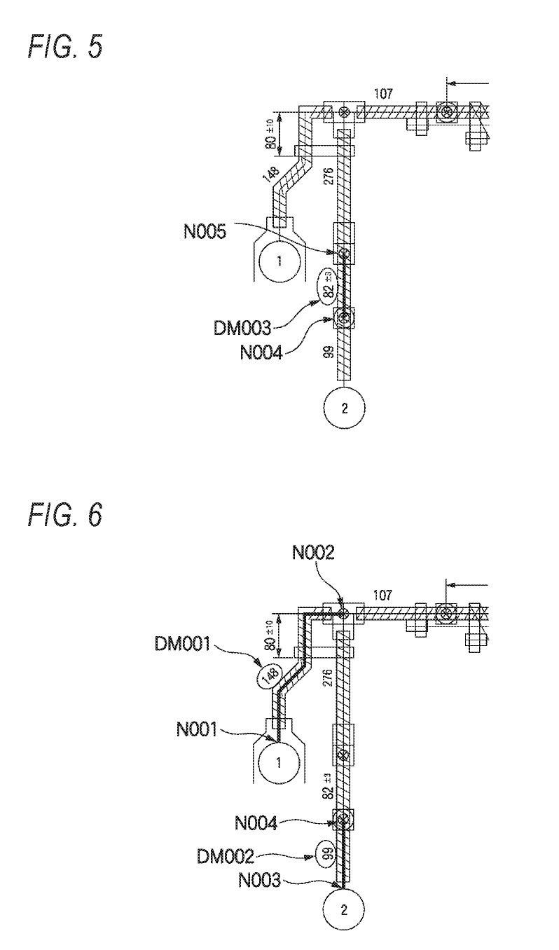

FIG. 5 shows a region A1 that is part of FIG. 3. A location where a clamp dimension should be measured is shown in FIG. 5.

In the embodiment, a segment whose nodes at its two ends are connected to a component “COMBINATION_PART” is defined as a clamp (C). In the region A1 of the wire harness shown in FIG. 5, the location (segment) one end of which is connected to node N0004 and the other end of which is connected to node N0005 is one clamp (C). In the MT data 21, a dimension having a dimension indication “DM003” is assigned to this clamp (C). Since clamps, terminals, and trunks are different in allowance, their dimensions need to be measured in such a manner that discrimination is made between them.

For example, to inspect the clamp dimension of the segment having the dimension indication “DM003,” it is necessary to find the two nodes N004 and N005, measure a dimension between these dimension measuring points in an actual wire harness, compare the measurement value with the numerical value of the dimension indication “DM003,” and judge whether the error is within the allowable range.

### <Terminal Dimension>

FIG. 6 also shows the region A1 which is part of FIG. 3. Locations where a terminal dimension should be measured are shown in FIG. 6.

In the embodiment, a segment one of whose nodes at its two ends is connected to a connector “COMPONENT” is defined as a terminal (T). In the region A1 of the wire harness shown in FIG. 6, the location (segment) one end of which is connected to node N001 and the other end of which is connected to node N002 is one terminal (T). The location (segment) one end of which is connected to node N003 and the other end of which is connected to node N004 is another terminal (T).

In the MT data 21, the former terminal (T) and the latter terminal (T) are assigned dimensions having dimension indications “DM001” and “DM002,” respectively.

### <Trunk Dimension>

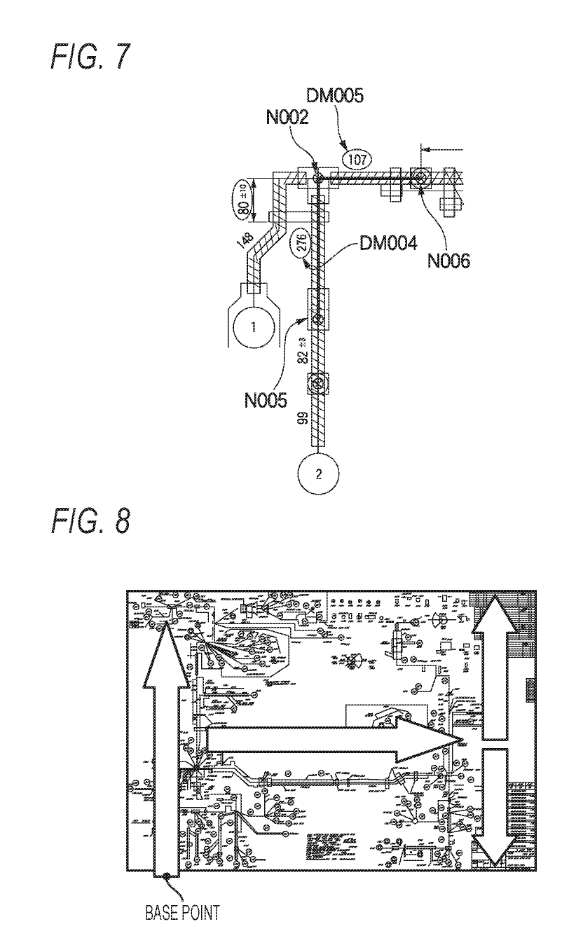

FIG. 7 also shows the region A1 which is part of FIG. 3. Locations where a dimension between trunks should be measured are shown in FIG. 7.

In the embodiment, a segment neither of whose nodes at its two ends is connected to a connector “COMPONENT” or a component “COMBINATION_PART” is defined as a trunk (M).

In the region A1 of the wire harness shown in FIG. 7, the location (segment) one end of which is connected to node N005 and the other end of which is connected to node N002 is one trunk (M). The location (segment) one end of which is connected to node N002 and the other end of which is connected to node N006 is another trunk (M). In the MT data 21, the former trunk (M) and the latter trunk (M) are assigned dimensions having dimension indications “DM004” and “DM005,” respectively.

### <Dimension Accuracy Check Sheet>

Dimension accuracy check sheet data 23 can be generated from the MT data 21 using the dimension accuracy check sheet generation function 140 of the support program shown in FIG. 2. It is possible to include, in the dimension accuracy check sheet data 23, pieces of address information assigned by the address drawing generation function 130.

The dimension accuracy check sheet data 23 may be output as a data file that is in such a form as to be able to be read and displayed using, for example, Excel which is spreadsheet software of Microsoft Corp. or output in the form of prints on sheets.

A dimension accuracy check sheet has, for each check item (segment), data items that are an address, a center value, T (terminal)/M (trunk)/C (clamp) distinction, a dimension, an allowance upper limit, an allowance lower limit, an allowance width.

By generating a dimension accuracy check sheet using pieces of address information assigned by the address drawing generation function 130, it becomes easy to display check items in such a manner that they are arranged in order of address numbers. For example, dimension inspection work can be done easily because a group of locations that should be subjected to dimension measurements together are arranged in order in a dimension accuracy check sheet.

### Modification

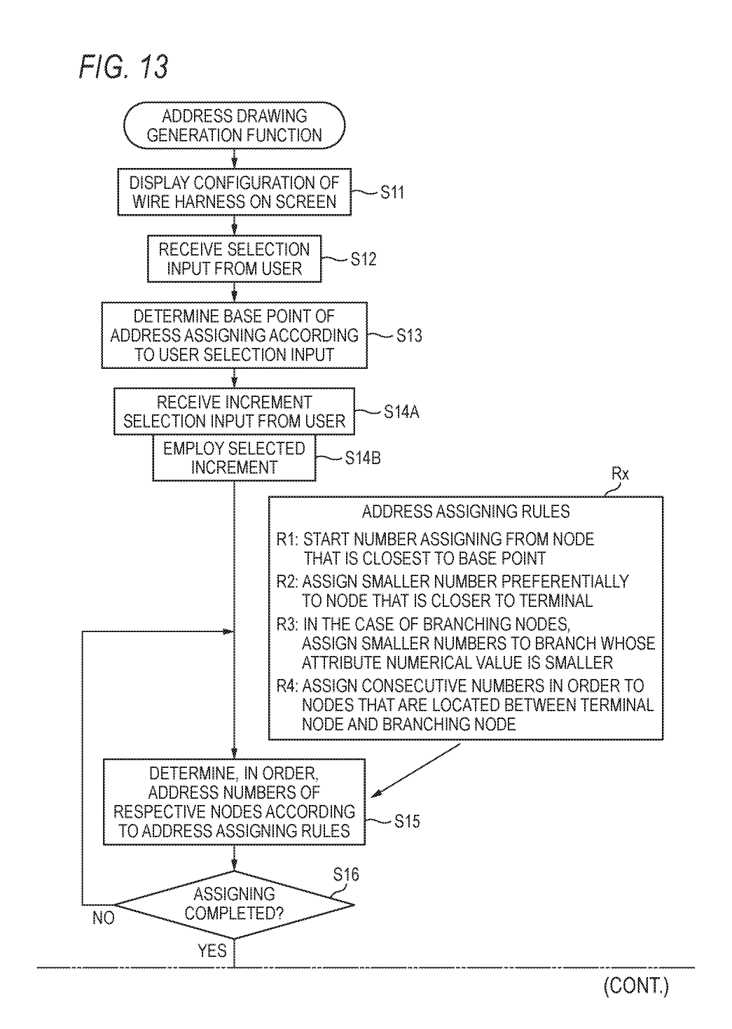

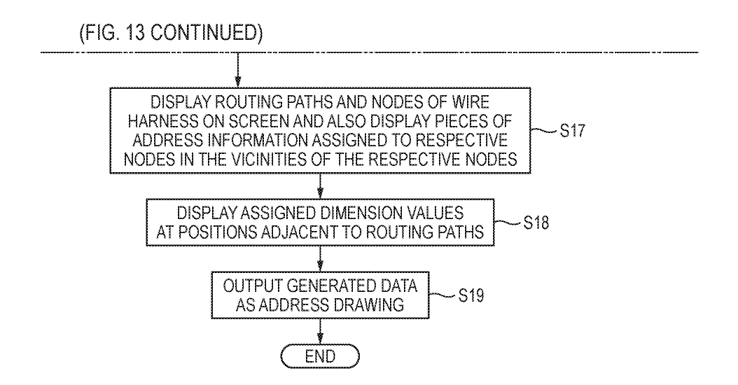

FIG. 13 shows a modification of the processing procedure shown in FIG. 1. The processing procedure shown in FIG. 13 is different from that shown in FIG. 1 in steps S14A and S14B.

At step S14A shown in FIG. 13, the computer 10 receives an increment selection input according to an input manipulation of a user. At step S14B, the computer 10 employs, as a parameter for assigning of address numbers, the increment that was selected at step S14A.

In the embodiment, the initial value of the increment is “1.” Thus, in the initial state, at step S15, address numbers assigned to the respective nodes are consecutive numbers “1,” “2,” “3,” “4,” “5,” . . . . However, they may occur a case that a new element is added to one wire harness. If consecutive address numbers have been assigned, no new number cannot be inserted between two of them.

If an increment “10” is selected by the user at step S14A, numbers “11,” “21,” “31,” “41,” “51,” . . . having the interval “10” are assigned at step S15. Thus, for example, for an element to be added, a new address number “25” can be inserted between the address numbers “21” and “31.”

The features of the above-described manufacture support method and manufacture support program according to the embodiment of the invention will be summarized below concisely in the form of items [1] to [9]:

[1] A manufacture support method for generating second design drawing data based on first design drawing data (MT data 21) representing a configuration of a wire harness, the manufacture support method comprising:

generating pieces of unique address information for nodes indicating dimension measuring points in the wire harness, respectively, and assigning the pieces of address information to respective nodes of a wire harness on the second design drawing data; and

in determining numbers of the pieces of unique address information, assigning numbers to the respective nodes along a routing path of the wire harness (step S15).

[2] The manufacture support method according to item [1], further comprising:

receiving a user input for selecting a particular constituent element to be made a base point among constituent elements of the wire harness (step S13); and

in determining numbers of the pieces of unique address information, assigning numbers to the respective nodes starting from a node that is closest to the base point (rule R1) which is a position of the selected constituent element.

[3] The manufacture support method according to item [1] or [2], wherein in determining numbers of the pieces of unique address information, a smaller number is assigned preferentially to a node that is closer to a terminal in a routing path of the wire harness (rule R2).

[4] The manufacture support method according to any one of items [1] to [3], wherein in determining numbers of the pieces of address information, in processing a branching node indicating a branching point of the routing path, a smaller number is assigned preferentially to a branch a numerical value of whose attribute representing its characteristic is smaller among branches branched at the branching point (rule R3).

[5] The manufacture support method according to any one of items [1] to [4], wherein in determining numbers of the pieces of unique address information, consecutive numbers are assigned, in order, to nodes that are located between a terminal node indicating one terminal in the routing path and a branching node indicating one branching point in the routing path (rule R4).

[6] The manufacture support method according to item [1], wherein in determining numbers of the pieces of unique address information, consecutive numbers or numbers having a specified increment are assigned to the nodes in order.

[7] The manufacture support method according to any one of items [1] to [6], further comprising: displaying the routing path and the nodes of the wire harness based on the first design drawing data or the second design drawing data, and displaying the pieces of unique address information assigned to the respective nodes in the vicinities of the respective nodes (step S17).

[8] The manufacture support method according to item [7], further comprising: displaying dimension values assigned as distances between respective pairs of nodes at positions adjacent to the routing paths.

[9] A non-transitory computer-readable storage medium, which includes a manufacture support program that causes a computer to execute the manufacture support method, according to any one of items [1] to [8].

What is claimed is:

1. A manufacture support method for generating second design drawing data based on first design drawing data representing a configuration of a wire harness, the manufacture support method comprising the steps of:
generating pieces of unique address information for nodes indicating dimension measuring points in the wire harness, respectively, and assigning the pieces of address information to respective nodes of a wire harness on the second design drawing data; and
in determining numbers of the pieces of unique address information, assigning numbers to the respective nodes along a routing path of the wire harness.

2. The manufacture support method according to claim 1, further comprising:
receiving a user input for selecting a particular constituent element to be made a base point among constituent elements of the wire harness; and
in determining numbers of the pieces of unique address information, assigning numbers to the respective nodes starting from a node that is closest to the base point which is a position of the selected constituent element.

3. The manufacture support method according to claim 1, wherein in determining numbers of the pieces of unique address information, a smaller number is assigned preferentially to a node that is closer to a terminal in a routing path of the wire harness.

4. The manufacture support method according to claim 1, wherein in determining numbers of the pieces of unique address information, in processing a branching node indicating a branching point of the routing path, a smaller number is assigned preferentially to a branch a numerical value of whose attribute representing its characteristic is smaller among branches branched at the branching point.

5. The manufacture support method according to claim 1, wherein in determining numbers of the pieces of unique address information, consecutive numbers are assigned, in order, to nodes that are located between a terminal node indicating one terminal in the routing path and a branching node indicating one branching point in the routing path.

6. The manufacture support method according to claim 1, wherein in determining numbers of the pieces of unique address information, consecutive numbers or numbers having a specified increment are assigned to the nodes in order.

7. The manufacture support method according to claim 1, further comprising:
displaying the routing path and the nodes of the wire harness based on the first design drawing data or the second design drawing data, and displaying the pieces of unique address information assigned to the respective nodes in the vicinities of the respective nodes.

8. The manufacture support method according to claim 7, further comprising:
displaying dimension values assigned as distances between respective pairs of nodes at positions adjacent to the routing path.

9. A non-transitory computer-readable storage medium, which includes a manufacture support program that causes a computer to execute the manufacture support method according to claim 1.
